(19) United States
(12) Patent Application Publication
(10) Pub. No.: US 2025/0104006 A1
(43) Pub. Date: Mar. 27, 2025

(54) Remote Assessment and Decision-Making System for Handling Returned Products

(71) Applicants: Isura Ranatunga, Concord, CA (US); Channa Ranatunga, Grand Prairie, TX (US); Sandeep Suresh, Emeryville, CA (US)

(72) Inventors: Isura Ranatunga, Concord, CA (US); Channa Ranatunga, Grand Prairie, TX (US); Sandeep Suresh, Emeryville, CA (US)

(21) Appl. No.: 18/373,303

(22) Filed: Sep. 27, 2023

(51) Int. Cl. G06Q 10/0837; G06Q 10/083

(52) U.S. Cl. CPC G06Q 10/0837; G06Q 10/0838

(57) ABSTRACT

The invention pertains to a computer-implemented method and system designed to modernize and optimize the handling of returned products in a warehouse setting. The system links returned items to their corresponding orders using identifiers like tracking or RMA numbers and retrieves pertinent Standard Operating Procedure (SOP) instructions for the warehouse operator. The condition of the returned products is recorded through high-quality images and videos during an initial inspection, which are then securely stored. This visual data, along with the respective SOP, can be remotely accessed and assessed by the brand or merchant team, or by an AI vision module, facilitating informed decision-making regarding the subsequent handling of the products—whether to resell, dispose of, donate, or refurbish.

### FIELD OF INVENTION

The invention pertains to the field of warehouse management, specifically to systems and methods for remote assessment and decision-making in the handling of returned products.

### BACKGROUND

In recent years, the evolution of online shopping has resulted in an increased volume of product returns to warehouses. Within the infrastructure of warehouse management systems, the handling of returned products introduces several challenges, particularly relating to the efficiency and consistency of processing such returns. The existing methodology necessitates warehouse workers to open each returned box, link the return to its associated order, evaluate the product condition, and subsequently determine the appropriate action for the product, be it reconditioning, restocking, or disposal.

An issue stemming from this approach is the complexity involved in adhering to the diverse Standard Operating Procedures (SOP) mandated by different brands or merchants. Given that each returned package may align with distinct SOPs based on its associated product and merchant, the complexity of the decision-making process is relatively high. These varying requirements demand extensive training for warehouse workers leading to errors.

Additionally, the involvement of human operators in determining the condition and appropriate action to take with a returned product is a bottleneck in process optimization since human operator assessments are subjective and vary in processing time from operator to operator.

Moreover, the absence of remote assessment capabilities in existing systems prevent merchants or brands from participating directly in the evaluation and decision-making process regarding their returned products.

It is within this context that the present invention is provided.

### SUMMARY

The disclosed invention principally pertains to a system devised for processing returned products, incorporating one or more cameras, a display screen, and one or more servers interconnected over a network. The cameras are programmed to capture image data depicting the condition of a returned product, along with an operator's assessment of the product. The servers are configured to execute a series of steps that encompass receiving and associating order information with corresponding orders, displaying Standard Operating Procedure (SOP) instructions, recording and providing image data for assessment, receiving decisions on the subsequent action for the returned product, and transmitting notifications of the decision and related instructions to the warehouse operator.

In some embodiments, the system encompasses one or more remote client user devices, enabling assessors, such as a remote merchant team, to operate said user devices. The introduction of remote client user devices aids in elevating the flexibility and responsiveness of the assessment process, allowing real-time evaluations and decisions from remote locations.

In certain embodiments, the one or more servers are further refined to facilitate real-time communication between the warehouse operator and the remote brand or merchant team. This feature augments the collaborative aspect of the system, providing instantaneous dialogue channels for clarifications, discussions, and prompt decision-making.

In several embodiments, the servers are also designed to dispatch notifications to an associated merchant team upon receiving a new returned product. This propels the initiation of the assessment and decision-making process, ensuring timely and efficient handling of returned items.

In specific embodiments, the system is equipped with an intelligent Computer Vision module operated via the one or more servers. This module processes image data to extract indicative features of the condition of the returned items and to identify anomalies, defects, or damages, thereby enhancing the accuracy and objectivity of the assessment process. Additionally, it may be configured to further process the image data to identify visual information from product packaging such as product metadata like brand, name, size, color, etc.

In particular embodiments, the system includes one or more scanners to link identifiers from returned products to order information, and the order information may include various identifiers like tracking numbers, Return Merchandise Authorization (RMA) numbers, customer information, and purchase order numbers. This feature reinforces the precision in associating returned products with corresponding orders in the order management system.

In some embodiments, the system integrates a computer terminal facilitating interactions between the operator and the system servers. This terminal enables operators to input assessments and receive instructions, streamlining the communication and task execution within the warehouse environment.

In some embodiments, the servers are developed to periodically refresh the SOP instructions, reflecting revisions made by associated merchants. This ensures the continuous relevance and accuracy of the SOPs, aligning the procedures with the dynamic requirements of the merchants.

In additional embodiments, the servers are proficient in cross-verifying the extracted order information with the available details in the order management system. This ability enhances the reliability of associating returned products with the correct orders, mitigating errors and discrepancies.

In certain embodiments, the servers employ the extracted order information to draw historical return data for the associated customer or product. This function enriches the assessment and decision-making process, providing valuable insights and historical contexts for the handling of the returned products.

### BRIEF DESCRIPTION OF THE DRAWINGS

Various embodiments of the invention are disclosed in the following detailed description and accompanying drawings.

FIG. 1 shows a system architecture comprising components such as a warehouse operator, scanner, camera, display screen, server/cloud infrastructure, remote user device, and AI vision module, working together to manage returned products.

FIG. 2 outlines a method for managing returned products, detailing steps from receiving and associating order information, displaying SOPs, recording product condition, to deciding and executing subsequent actions for the returns.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

A warehouse operator or operator as described herein may refer to a human worker, a robotic grip effector type machine, or both.

The terms “first,” “second,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

### Description of Drawings

The present invention relates generally to a system designed for the processing of returned products. This system primarily consists of interconnected components including one or more cameras, a display screen, and one or more servers operating over a network. The system is structured to facilitate a workflow in processing returned products in a warehouse setting, leveraging technology to associate returned items with their respective orders and to adhere strictly to the specific Standard Operating Procedures (SOP) outlined for assessment.

The system employs the cameras to capture and record image data detailing the condition of a returned product and to record an operator's assessment of the said product. This data serves as a visual insight into the state of the returned products, contributing to the objective assessment and decision-making process concerning the subsequent action to be taken for the returned products.

Furthermore, the system utilizes the servers to execute an array of steps for efficient product return processing. These steps include receiving and associating order information with corresponding orders in an order management system, retrieving related merchant information and SOPs from a database, and displaying these SOP instructions to an operator via the display screen. These servers also play a role in recording and providing the captured image data for assessment, receiving the decisions on the subsequent actions for the returned product, and relaying notifications of the decisions and accompanying instructions to the warehouse operator.

The display screen presents the SOP instructions to the warehouse operator. This ensures that the operators are well-informed of the procedural guidelines, enabling adherence to the correct protocols during the handling and assessment of the returned products.

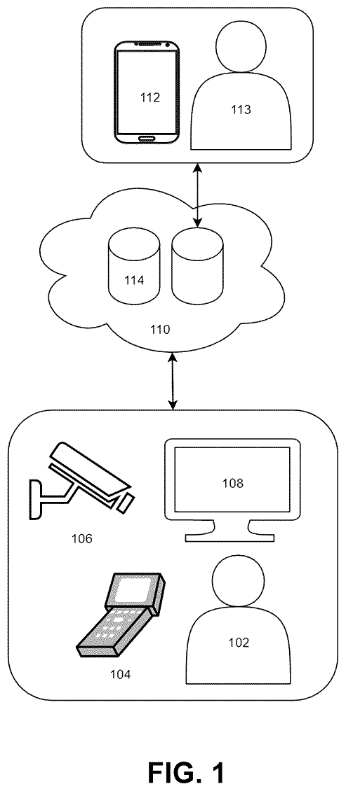

FIG. 1 illustrates a block diagram displaying the layout of an exemplary system architecture. The diagram commences with the depiction of a warehouse operator 102 who interacts with several components to facilitate the handling of returned products.

In the present example a scanner 104 is employed to read barcodes or QR codes on the returned packages. This scanner 104 plays a role in linking returned items to their respective orders, using information such as tracking or RMA numbers.

Positioned in proximity to the scanner 104 is a camera 106, purposed for recording high-definition images and videos of the returned products during the initial inspection process. The captured image data may also include visually discernible information related to the product packaging such as barcodes, QR codes, text read by OCR, and other metadata.

Adjacent to the camera 106 is a display screen 108. This component provides the warehouse operator 102 with pertinent Standard Operating Procedure instructions and other relevant information related to the returned products, ensuring a uniform approach in handling the returns in accordance with the merchant's preferences. If the returned order has no RMA or order information available, the operator will have the ability to collect and transmit information about an order during their assessment via an interface connected to the display screen 108.

A server or cloud infrastructure 110 is incorporated to securely house the recorded images, videos, and other relevant data, facilitating remote access and review by the brand or merchant team.

Further depicted is a remote user device 112, manipulated by a merchant assessor 113. This device 112 is instrumental in viewing the recorded image data and the condition of the returned product, allowing the merchant assessor to make informed decisions regarding the subsequent handling of the returned product.

In some instances where an AI vision module 114 is utilized as the assessor instead of the merchant. This module 114 processes and evaluates the condition of the returned products, executing decisions derived from the outputs of machine learning models and artificial intelligence algorithms.

The system connects returned boxes to order records in the order management system. The relevant standard operating procedure instructions are conveyed to the warehouse operator 102. Recording of images and videos of the returned items enables the remote brand teams or the AI vision module 114 to review and decide on the appropriate course of action for the returned products, whether to resell, trash, recondition, etc. Post this decision-making, the products are processed accordingly within the warehouse, aligning with the predetermined decision.

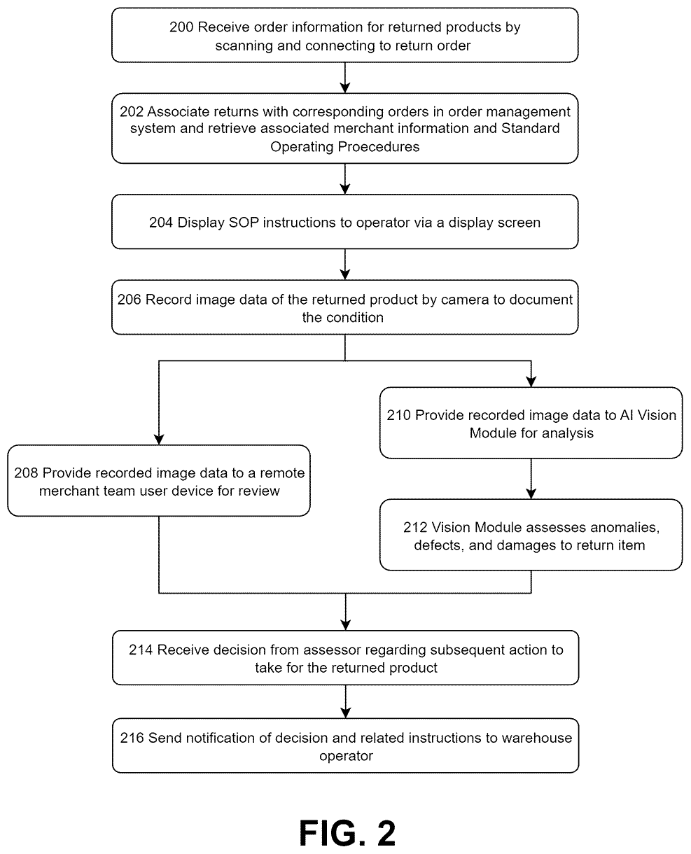

FIG. 2 illustrates the streamlined method for handling returned products.

The method begins with Step 200, where the servers receive order information for returned products by utilizing scanners to connect returned items to their respective orders using information like tracking or RMA numbers.

In Step 202, these servers associate the received order information with the corresponding orders in an order management system and retrieve the associated merchant information and SOPs from a database. This step links each returned item to the relevant client or merchant business and provides the warehouse worker with the corresponding standard operating procedure instructions.

Subsequently, in Step 204, the servers facilitate the display of the SOP instructions to an operator via a display screen, allowing the operator to understand and follow the necessary instructions and align their actions with predetermined standards.

Next, in Step 206, the servers manage the recording of image data of the returned product by a camera to document the condition of the returned products accurately, enabling remote assessment by either a brand or merchant or an AI vision module.

The image data recorded at this step is stored in the system database, both the video inspection conducted by the AI vision module and/or the inspection assessments made by the warehouse operator. Optionally, these recordings may be shared with the customer who initiated the return. This function serves as an optional step, and may be implemented automatically or shared selectively at the discretion of the merchant team. This capability affirms to customers that their returned items have been received and processed appropriately, and is useful when a customer sends an incorrect item for return. It enables the merchant team to maintain transparency by providing tangible evidence of the item's condition and the conducted assessments, which can be relied upon when a refund is to be denied.

In Path A, representing Step 208, the servers provide the recorded image data to a remote merchant team user device for review, allowing specialized decision-making to be handled by teams with a deeper understanding of the product.

Conversely, in Path B, representing Step 210, the servers relay the recorded image data to the AI Vision Module, enabling automated analysis and detection 212 of the returned items' condition to decide the subsequent action based on the detected anomalies, defects, or damages.

After these paths, in Step 214, the servers receive a decision from the assessor regarding the subsequent action to take for the returned product.

Finally, in Step 216, the servers send a notification of the decision and related instructions to the warehouse operator, facilitating immediate actions like reselling, trashing, or reconditioning of the returned product, in accordance with the received instructions.

### AI Vision Module Implementations

In an alternative embodiment of the invention, an AI Vision Module may act as the assessor of the products' condition. It should be noted that the components and implementations outlined herein are illustrative examples, and variations utilizing other suitable programs or software architectures can also be adopted.

The Computer Vision system in this embodiment may be configured to process images and videos, utilizing illustrative image processing libraries like OpenCV or equivalent, to extract features indicative of the condition of returned items. It may implement object detection and recognition to assess anomalies, defects, or damages within the returned items.

Convolutional Neural Networks (CNNs) would be particularly suitable for the task due to their proven efficacy in image analysis tasks, enabling the extraction of hierarchical features from the images of returned products. CNNs can be used to identify damages, anomalies, and defects in the products by learning spatial hierarchies of features. Furthermore, incorporating object detection models, such as YOLO (You Only Look Once) or Faster R-CNN, can facilitate the localization and classification of multiple defects within the products. A combination of CNNs with other neural network architectures like Recurrent Neural Networks (RNNs) can also be considered to analyze sequences and temporal dependencies in the image data.

Machine Learning models within this embodiment may be developed and trained using exemplary frameworks such as TensorFlow or PyTorch or other suitable frameworks, and they may employ supervised or unsupervised learning approaches based on historical data patterns related to product conditions and suitable actions. These models aim to predict appropriate actions based on the extracted features.

Artificial Intelligence algorithms may be designed to structure and execute decisions, integrating with the outputs from the Machine Learning models. They may incorporate predefined rules, constraints, or decision trees related to product handling. These algorithms are optimized to prioritize actions considering various factors, and they may employ equivalent rule-based systems or decision trees to associate specific product conditions with suitable actions, adhering to Standard Operating Procedures (SOPs) and merchant preferences.

Integration and interoperability with existing systems are crucial in this illustrative embodiment. Suitable APIs and middleware solutions may be employed to connect the developed systems with other integral components within the system, facilitating seamless communication and ensuring the interoperability of the system with various software components.

User interfaces in this example are designed to allow interactions for reviewing decisions made by the Artificial Intelligence algorithms and for providing feedback, fostering continuous improvements in model and algorithm accuracy through the implementation of feedback loops.

The deployment of software components in this embodiment can leverage suitable containerization technologies and be orchestrated to scale using appropriate tools, operating on exemplary or other suitable cloud computing resources to leverage the associated services and infrastructure.

### Network Components

A server as described herein can be any suitable type of computer. A computer may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system and related methods have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system for processing returned products, comprising:
one or more cameras configured to record image data of the condition of a returned product and to record a warehouse operator assessment of the returned product;
a display screen configured to display a set of Standard Operating Procedure (SOP) instructions to the warehouse operator; and
one or more servers operating over a network and being configured to carry out the steps of:
receiving order information for the returned product;
associating the order information with a corresponding order in an order management system and retrieving associated merchant information and SOP instructions associated with said merchant from a database;
displaying the retrieved SOP instructions associated with the merchant to the warehouse operator via the display screen;
recording image data of the returned product;
transmitting the recorded image data of the returned product's condition to a user device of an assessor for the associated merchant;
receiving a decision from the assessor regarding an action to take for the returned product; and
sending a notification of the decision and related instructions to the warehouse operator.

2. (canceled)

3. The system of claim 1, wherein the one or more servers are further configured to enable real-time communication between the warehouse operator and the associated merchant.

4. The system of claim 1, wherein the one or more servers are further configured to send a notification to the associated merchant upon retrieving the associated merchant information for the returned product.

5. (canceled)

6. (canceled)

7. The system of claim 1, further comprising one or more scanners configured to facilitate the receiving of the order information by scanning identifiers from the returned product.

8. The system of claim 1, wherein the order information is selected from a group consisting of a tracking number, a Return Merchandise Authorization (RMA) number, customer information, and a purchase order number, to associate the returned product with a corresponding order in the order management system.

9. The system of claim 1, further comprising a computer terminal allowing interactions between the warehouse operator and the one or more servers to input the assessment and receive the SOP instructions.

10. The system of claim 1, wherein the decision regarding the subsequent action for the returned order is selected from: reselling, trashing, or reconditioning the returned product.

11. The system of claim 1, wherein the one or more servers are further configured to periodically update the SOP instructions based on revisions made by associated merchants.

12. The system of claim 1, wherein the one or more servers are further configured to cross-verify the received order information with details available in the order management system to confirm the association of the returned product with the corresponding order.

13. The system of claim 1, wherein the one or more servers are further configured to use the received order information to retrieve historical return data for an associated customer or the returned product, aiding in the decision regarding the subsequent action.

14. The system of claim 1, wherein the one or more servers are further configured to share the recorded image data with a client associated with the return order.
